(19) United States
(12) Patent Application Publication
(10) Pub. No.: US 2026/0170728 A1
(43) Pub. Date: Jun. 18, 2026

(54) TRAINING METHOD FOR IMAGE GENERATION MODEL, IMAGE GENERATION METHOD, AND RELATED DEVICE

(71) Applicant: Beijing Zitiao Network Technology Co., Ltd., Beijing (CN)

(72) Inventor: Xiao LI, Beijing (CN)

(21) Appl. No.: 19/347,596

(22) Filed: Oct. 1, 2025

(30) Foreign Application Priority Data
Dec. 16, 2024 (CN) 202411855528.7

(51) Int. Cl. G06T 11/60; G06T 5/70

(52) U.S. Cl. CPC G06T 11/60; G06T 5/70; G06T 2207/20081

(57) ABSTRACT

The present disclosure provides a training method for an image generation model including an image generation module and a layout control module. An output of the layout control module is an input of the image generation module. The method includes: obtaining first training data; using description information of a first training image as an input of the image generation module, and training the image generation module using the first training image as a label; using description information of a second training image and a layout image of the second training image as inputs of the layout control module, to obtain a layout control feature; and using the description information of the second training image and the layout control feature output by the layout control module as inputs of the trained image generation module, and training the layout control module using the second training image as a label.

### CROSS-REFERENCE TO RELATED APPLICATIONS

The present application is based on and claims priority of CN Application No. 202411855528.7, filed on December 16, 2024, the disclosure of which is incorporated by reference herein in its entirety.

### TECHNICAL FIELD

The present disclosure relates to the field of computer technologies, and in particular, to a training method for an image generation model, an image generation method, a training apparatus for an image generation model, an image generation apparatus, an electronic device, a computer-readable storage medium, and a computer program product.

### BACKGROUND

In an image generation scenario, a user (for example, a business party with an image generation requirement) may generate an image by using an image generation model. Generally, an image may include a plurality of foreground objects. When the user needs to implement controllable generation of an image, the user may construct control information (for example, text with control information or a picture with control information) for controlling the foreground objects, and input the control information to the image generation model, so that the image generation model generates, based on the control information, an image that satisfies the control information.

However, in the related art, it is difficult to accurately control positions of foreground objects in a generated image by using concise control information, and a correlation between a background picture and the foreground objects is low, resulting in low image generation quality.

### SUMMARY

The present disclosure provides a training method for an image generation model. The image generation model obtained through training by using the method may comprehensively consider a correlation between a background picture and foreground objects in a generated image, and implement controllable layout at the same time, to meet diversified image generation requirements. The present disclosure further provides an image generation method, a training apparatus for an image generation model, an image generation apparatus, an electronic device, a computer-readable storage medium, and a computer program product that correspond to the foregoing method.

According to a first aspect, the present disclosure provides a training method for an image generation model, where the image generation model includes an image generation module and a layout control module, an output of the layout control module is one input of the image generation module, the image generation module is configured to generate an image, and the layout control module is configured to control a layout of foreground objects in the image; and the method includes:

obtaining first training data, where the first training data includes a first training image and description information of the first training image, and the description information of the first training image is configured to describe a background picture and foreground objects of the first training image;

using the description information of the first training image as an input of the image generation module, and training the image generation module by using the first training image as a label;

after completing training of the image generation module, obtaining second training data, where the second training data includes a second training image, description information of the second training image, and a layout image of the second training image, the description information of the second training image is configured to describe a background picture and foreground objects of the second training image, and the layout image of the second training image is configured to indicate an area that does not include a foreground object in the second training image;

using the description information of the second training image and the layout image of the second training image as inputs of the layout control module, to obtain a layout control feature output by the layout control module; and

using the description information of the second training image and the layout control feature output by the layout control module as inputs of the trained image generation module, and training the layout control module by using the second training image as a label.

According to a second aspect, the present disclosure provides an image generation method, including:

obtaining first description information and a first layout image, where the first description information is configured to describe a background picture and foreground objects of a desired image, and the first layout image is configured to indicate an area that does not include a foreground object in the desired image;

inputting the first description information and the first layout image into an image generation model, so that the image generation model extracts a layout control feature based on the first layout image, and generates a first image including the background picture and the foreground objects based on the first description information and the layout control feature; and

obtaining the first image output by the image generation model, where the image generation model is obtained through training based on a second image, description information of the second image, and a second layout image, the description information of the second image is configured to describe a background picture and foreground objects of the second image, and the second layout image is configured to indicate an area that does not include a foreground object in the second image.

According to a third aspect, the present disclosure provides a training apparatus for an image generation model, where the image generation model includes an image generation module and a layout control module, an output of the layout control module is one input of the image generation module, the image generation module is configured to generate an image, and the layout control module is configured to control a layout of foreground objects in the image; and the apparatus includes:

an obtaining module, configured to obtain first training data, where the first training data includes a first training image and description information of the first training image, and the description information of the first training image is configured to describe a background picture and foreground objects of the first training image;

a training module, configured to use the description information of the first training image as an input of the image generation module, and train the image generation module by using the first training image as a label;

the obtaining module is further configured to: after completing training of the image generation module, obtain second training data, where the second training data includes a second training image, description information of the second training image, and a layout image of the second training image, the description information of the second training image is configured to describe a background picture and foreground objects of the second training image, and the layout image of the second training image is configured to indicate an area that does not include a foreground object in the second training image;

a processing module, configured to use the description information of the second training image and the layout image of the second training image as inputs of the layout control module, to obtain a layout control feature output by the layout control module; and

the training module is further configured to use the description information of the second training image and the layout control feature output by the layout control module as inputs of the trained image generation module, and train the layout control module by using the second training image as a label.

According to a fourth aspect, the present disclosure provides an image generation apparatus, including:

an obtaining module, configured to obtain first description information and a first layout image, where the first description information is configured to describe a background picture and foreground objects of a desired image, and the first layout image is configured to indicate an area that does not include a foreground object in the desired image;

an inputting module, configured to input the first description information and the first layout image into an image generation model, so that the image generation model extracts a layout control feature based on the first layout image, and generates a first image including the background picture and the foreground objects based on the first description information and the layout control feature; and

an outputting module, configured to obtain the first image output by the image generation model, where the image generation model is obtained through training based on a second image, description information of the second image, and a second layout image, the description information of the second image is configured to describe a background picture and foreground objects of the second image, and the second layout image is configured to indicate an area that does not include a foreground object in the second image.

According to a fifth aspect, the present disclosure provides an electronic device, where the electronic device includes a processor and a memory. The processor and the memory communicate with each other. The processor is configured to execute instructions stored in the memory, to cause the electronic device to perform the training method for an image generation model according to the first aspect or any one of the implementations of the first aspect, or perform the image generation method according to the second aspect or any one of the implementations of the second aspect.

According to a sixth aspect, the present disclosure provides a computer-readable storage medium having instructions stored thereon, where the instructions instruct an electronic device to perform the training method for an image generation model according to the first aspect or any one of the implementations of the first aspect, or perform the image generation method according to the second aspect or any one of the implementations of the second aspect.

According to a seventh aspect, the present disclosure provides a computer program product including instructions that, when executed on an electronic device, cause the electronic device to perform the training method for an image generation model according to the first aspect or any one of the implementations of the first aspect, or perform the image generation method according to the second aspect or any one of the implementations of the second aspect.

In the present disclosure, based on the implementations provided in the foregoing aspects, further combination may be performed to provide more implementations.

### BRIEF DESCRIPTION OF THE DRAWINGS

In order to more clearly explain the technical methods in the embodiments of the present disclosure, the drawings required to be used in the embodiments will be briefly described below.

FIG. 1 is a schematic diagram of a structure of an image generation model according to an embodiment of the present disclosure;

FIG. 2 is a schematic flowchart of a training method for an image generation model according to an embodiment of the present disclosure;

FIG. 3 is a schematic diagram of a layout image according to an embodiment of the present disclosure;

FIG. 4 is a schematic flowchart of an image generation method according to an embodiment of the present disclosure;

FIG. 5 is a schematic diagram of a structure of an image generation model according to an embodiment of the present disclosure;

FIG. 6 is a schematic diagram of a structure of a training apparatus for an image generation model according to an embodiment of the present disclosure;

FIG. 7 is a schematic diagram of a structure of an image generation apparatus according to an embodiment of the present disclosure; and

FIG. 8 is a schematic diagram of a structure of an electronic device according to an embodiment of the present disclosure.

### DETAILED DESCRIPTION OF EMBODIMENTS

It may be learned from the foregoing technical solutions that the present disclosure has the following advantages.

The present disclosure provides a training method for an image generation model. The image generation model includes an image generation module and a layout control module. An output of the layout control module is one input of the image generation module. The image generation module is configured to generate an image. The layout control module is configured to control a layout of foreground objects in the image. The method includes: first, obtaining first training data, where the first training data includes a first training image and description information of the first training image, and the description information of the first training image is configured to describe a background picture and foreground objects of the first training image; using the description information of the first training image as an input of the image generation module, and training the image generation module by using the first training image as a label; after completing training of the image generation module, obtaining second training data, where the second training data includes a second training image, description information of the second training image, and a layout image of the second training image, the description information of the second training image is configured to describe a background picture and foreground objects of the second training image, and the layout image of the second training image is configured to indicate an area that does not include a foreground object in the second training image; using the description information of the second training image and the layout image of the second training image as inputs of the layout control module, to obtain a layout control feature output by the layout control module; and using the description information of the second training image and the layout control feature output by the layout control module as inputs of the trained image generation module, and training the layout control module by using the second training image as a label.

In the method, the image generation module and the layout control module in the image generation model are separately trained in a step-by-step training manner. The image generation module is first trained. Because the description information of the first training image describes both the background picture and the foreground objects, the background picture and the foreground objects in a generated image may be generated at one time, to enhance a correlation between the background picture and the foreground objects. After the training of the image generation module is completed, the layout control module is trained in combination with the trained image generation module. Because the layout image of the second training image indicates an area that does not include a foreground object, an area in which a foreground object cannot be generated in a generated image may be controlled, to implement controllable layout. In this way, the image generation model obtained through training may comprehensively consider the correlation between the background picture and the foreground objects in the generated image, and implement controllable layout at the same time, to meet diversified image generation requirements.

The terms "first" and "second" in the embodiments of the present disclosure are used for descriptive purposes only, and cannot be understood as indicating or implying relative importance or implicitly indicating the number of indicated technical features. Therefore, a feature defined as "first" or "second" may explicitly or implicitly include one or more features.

Some technical terms and application scenarios involved in the embodiments of the present disclosure are first introduced.

An image generation process may be understood as a process of automatically generating a new image. Generally, an image generation model is used in the related field to generate an image. For example, the image generation model may be a diffusion model based on deep learning.

Generally, an image may include a plurality of foreground objects. For example, the foreground objects in the image may include people, objects, stickers, and the like. When a user (for example, a business party with an image generation requirement) needs to implement controllable generation of an image, the user may construct control information for controlling the foreground objects, and input the control information to the image generation model, so that the image generation model generates, based on the control information, an image that satisfies the control information.

In some examples, the control information may be text with control information. For example, the control information may be text for describing information such as a position, a shape, and a color of a foreground object. In some other examples, the control information may be a picture with control information. For example, the control information may be a contour image, a segmentation map, a joint image, a depth map, or the like of a foreground object.

In the related art, the control information may control a position of a foreground object. However, it is difficult for the foregoing method to accurately control the position of the foreground object in a generated image by using concise control information. Specifically, when the control information is text with control information, it is often difficult for the image generation model to understand the text (for example, "a is on the left of b", "c is in the lower right corner of the image", or the like) that is in the control information and that is configured to describe the position of the foreground object, and it is difficult for the image generation model to accurately control the position of the foreground object in the generated image by combining the text having control information. When the control information is a picture with control information, high precision is required for the control information. The picture with control information needs to accurately and carefully depict information such as a contour and a depth of the foreground object. However, the control information with high precision is obtained from a high-quality reference image, and it is difficult to obtain a large number of accurate reference images in a scenario of batch image generation.

Therefore, to effectively control the positions of the foreground objects in the image, the related art further proposes a multi-step image generation manner, that is, separately generating the background picture and the foreground objects, and then combining the foreground objects on the background picture by using separate position control information, to generate a final image. However, the foregoing manner also has the following problems: The multi-step image generation manner has a complex process, and a training process of the image generation model is cumbersome. In addition, because the background picture and the foreground objects are separately generated, the correlation between the background picture and the foreground objects is low. In addition, the position control information often defines the positions of the foreground objects, and the foreground objects are placed in the positions defined by the position control information, resulting in limited diversity. How to enable the background picture and the foreground objects in the image generated by the image generation model to have a specific correlation and follow specific layout information has become an urgent problem to be solved in the related art.

In view of this, the present disclosure provides a training method for an image generation model. The image generation model includes an image generation module and a layout control module. An output of the layout control module is one input of the image generation module. The image generation module is configured to generate an image. The layout control module is configured to control a layout of foreground objects in the image. The method includes: first, obtaining first training data, where the first training data includes a first training image and description information of the first training image, and the description information of the first training image is configured to describe a background picture and foreground objects of the first training image; using the description information of the first training image as an input of the image generation module, and training the image generation module by using the first training image as a label; after completing training of the image generation module, obtaining second training data, where the second training data includes a second training image, description information of the second training image, and a layout image of the second training image, the description information of the second training image is configured to describe a background picture and foreground objects of the second training image, and the layout image of the second training image is configured to indicate an area that does not include a foreground object in the second training image; using the description information of the second training image and the layout image of the second training image as inputs of the layout control module, to obtain a layout control feature output by the layout control module; and using the description information of the second training image and the layout control feature output by the layout control module as inputs of the trained image generation module, and training the layout control module by using the second training image as a label.

In the method, the image generation module and the layout control module in the image generation model are separately trained in a step-by-step training manner. The image generation module is first trained. Because the description information of the first training image describes both the background picture and the foreground objects, the background picture and the foreground objects in a generated image may be generated at one time, to enhance a correlation between the background picture and the foreground objects. After the training of the image generation module is completed, the layout control module is trained in combination with the trained image generation module. Because the layout image of the second training image indicates an area that does not include a foreground object, an area in which a foreground object cannot be generated in a generated image may be controlled, to implement controllable layout. In this way, the image generation model obtained through training may comprehensively consider the correlation between the background picture and the foreground objects in the generated image, and implement controllable layout at the same time, to meet diversified image generation requirements.

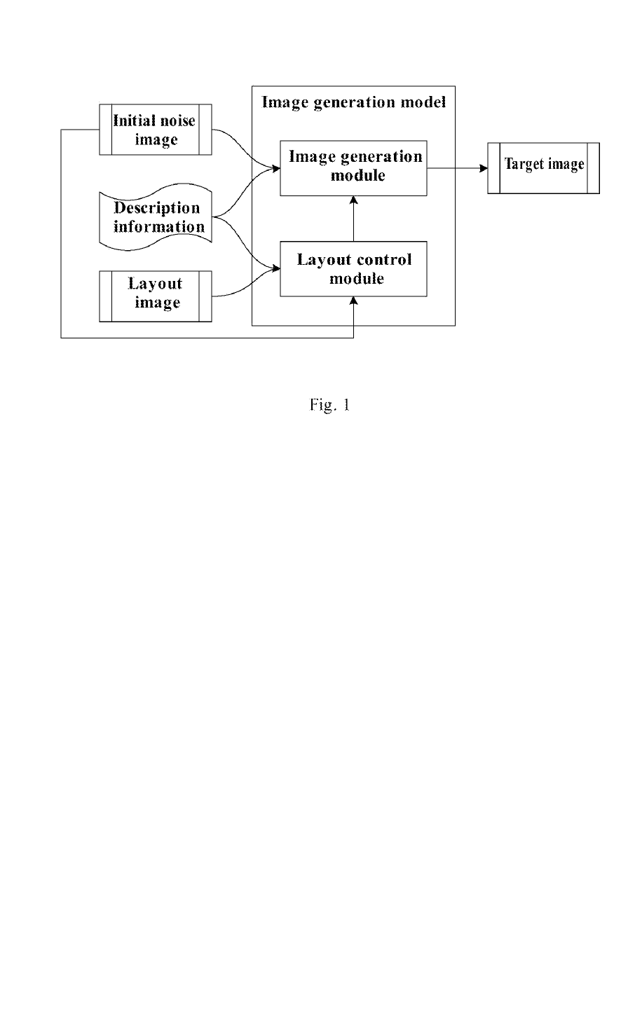

To facilitate understanding of the technical solutions provided in the embodiments of the present disclosure, the following descriptions are made with reference to the drawings. First, the image generation model is introduced. FIG. 1 is a schematic diagram of a structure of an image generation model according to an embodiment of the present disclosure. In this embodiment of the present disclosure, the image generation model may be a diffusion model, and the image generation model may include an image generation module and a layout control module.

The layout control module is configured to control a layout of foreground objects in an image. Inputs of the layout control module include an initial noise image, description information, and a layout image. An output of the layout control module is a layout control feature. The image generation module is configured to generate an image, for example, generate an image based on text, or generate an image based on text and control information. Inputs of the image generation module include an initial noise image, description information, and a layout control feature. An output of the image generation module is a target image.

The initial noise image may be understood as an image composed of initial noise (for example, a random number). Generally, the initial noise image has the same size as the layout image and the target image. The image generation module may use the initial noise image as a reference, and generate the target image based on the initial noise image. In this way, the layout control module may extract the layout control feature based on the initial noise image in combination with the description information and the layout image, to increase controllability of the target image. The image generation module may generate, based on the initial noise image in combination with the description information and the layout control feature, the target image that satisfies the description information and the layout control feature, to implement image generation.

It should be noted that the image generation model may include more modules in addition to the image generation module and the layout control module. For example, the image generation model may further include a variational autoencoder module. The variational autoencoder module includes an encoder and a decoder. The encoder is configured to perform downsampling on the initial noise image (for example, compress a 512 × 512 initial noise image into a 16 × 16 image). The decoder is configured to perform upsampling on an image output by the image generation module (for example, restore a 16 × 16 image output by the image generation module to a 512 × 512 target image).

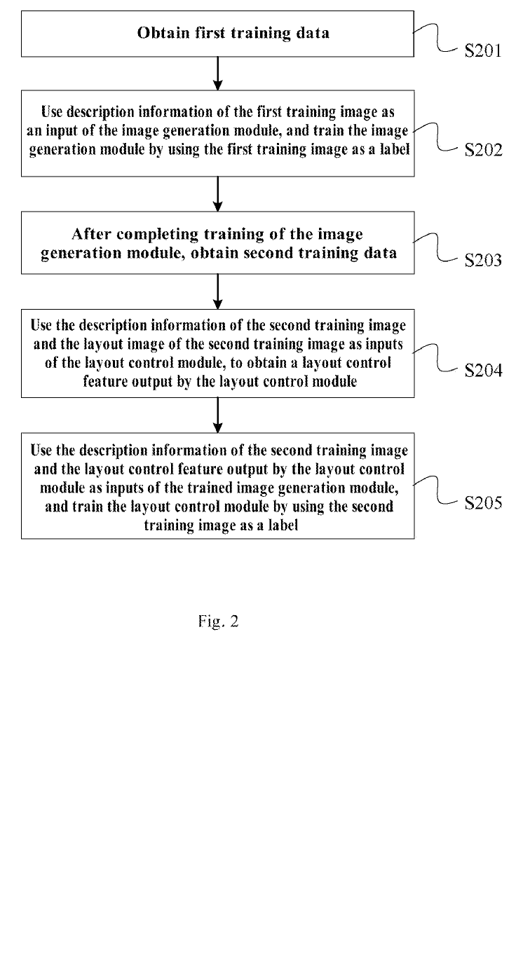

Next, based on the image generation model shown in FIG. 1, a training process of the image generation model is described. FIG. 2 is a schematic flowchart of a training method for an image generation model. The method specifically includes the following steps.

S201: Obtain first training data.

In this embodiment of the present disclosure, the image generation model is trained in a multi-step training manner. In a first training step, only the image generation module is trained, that is, only a model parameter of the image generation module is adjusted.

The first training data may be understood as training data for training the image generation module. The first training data may include a first training image and description information of the first training image. The description information of the first training image may be configured to describe a background picture and foreground objects of the first training image. In this embodiment of the present disclosure, the description information of the first training image may be described in a natural language, and represents natural language content, that is, the description information of the first training image may describe image content of the first training image in the form of a natural language.

The background picture may be understood as a picture that serves as a background in the first training image, and a size of the background picture may be the same as a size of the first training image. The foreground objects may be understood as objects other than the background picture in the first training image, and generally, a plurality of foreground objects may be included. For example, when the description information of the first training image is "a dog playing ball on a beach with the beach as a background in a picture", the beach may be the background picture, and the puppy and the ball may be the foreground objects.

That is, considering that the image generation module may generate an image based on text, the first training image and the description information of the first training image are selected as the first training data, to specifically train the image generation module.

S202: Use the description information of the first training image as an input of the image generation module, and train the image generation module by using the first training image as a label.

In this embodiment of the present disclosure, training of the image generation model may be supervised training, and the label may be understood as a correct output result in the supervised training.

During specific implementation, the description information of the first training image is input to the image generation module. The image generation module gradually performs denoising processing on the initial noise image, and injects a semantic feature of the description information of the first training image in the denoising processing process, to generate an output image that matches the description information of the first training image.

Then, a loss function value is calculated based on the output image of the image generation module and the first training image that is the label. The loss function value may represent a difference degree between the output image of the image generation module and the first training image. A model parameter of the image generation module is adjusted to minimize the loss function value, to complete one round of training process in the training of the image generation module.

The foregoing steps are repeated, and a plurality of rounds of training processes are performed in the first training step. The first training image in each round of training process is different. When the difference degree between the output image of the image generation module and the first training image meets a training end condition, the training of the image generation module ends. In this way, when the input is the description information of the first training image, the image generation module may output an image similar to the first training image. In addition, because the description information of the first training image describes both the background picture and the foreground objects, the trained image generation module may generate the background picture and the foreground objects at one time.

S203: After completing the training of the image generation module, obtain second training data.

Completing the training of the image generation module may be understood as completing the first training step, and after the first training step is completed, the second training step starts. In the second training step, the layout control module is trained by taking advantage of the trained image generation module, that is, a model parameter of the layout control module is adjusted.

The second training data may be understood as training data for training the layout control module. The second training data may include a second training image, description information of the second training image, and a layout image of the second training image. The description information of the second training image may be configured to describe a background picture and foreground objects of the second training image. The layout image of the second training image may be used to indicate an area that does not include a foreground object in the second training image.

That is, in this embodiment of the present disclosure, the layout image is only used to inform the layout control module of the area in which a foreground object cannot be generated, and a specific position of the foreground object is not limited. In this way, the image generation model may freely generate an image, and the specific position, contour, style, pattern, or the like of the foreground object is not limited.

S204: Use the description information of the second training image and the layout image of the second training image as inputs of the layout control module, to obtain a layout control feature output by the layout control module.

The layout control feature may be understood as a feature related to controlling an area in which the foreground object is located. Ina a specific implementation, the description information of the second training image and the layout image of the second training image are input to the layout control module. The layout control module extracts the layout control feature from the layout image of the second training image based on the initial noise image in combination with the description information of the second training image, and outputs the layout control feature.

S205: Use the description information of the second training image and the layout control feature output by the layout control module as inputs of the trained image generation module, and train the layout control module by using the second training image as a label.

In this embodiment of the present disclosure, the trained image generation module is configured to generate an output image in combination with the layout control feature output by the layout control module. In a specific implementation, the description information of the second training image and the layout control feature are input to the image generation module. The image generation module injects a semantic feature of the description information of the second training image and the layout control feature based on the initial noise image, to generate an output image that matches the description information of the second training image and matches the layout image.

Then, a loss function value is calculated based on the output image of the image generation module and the second training image that is the label. The loss function value may represent a difference degree between a position of a foreground object in the output image of the image generation module and a position of a foreground object in the second training image. The model parameter of the layout control module is adjusted to minimize the loss function value, to complete one round of training process in the training of the layout control module.

The foregoing steps are repeated, and a plurality of rounds of training processes are performed in the second training step. The second training image in each round of training process is different. When the difference degree between the output image of the image generation module and the second training image meets a training end condition, the training of the layout control module ends. In this way, when the input is the layout image of the second training image, the image generation module may output an image that satisfies the layout image of the second training image. In addition, because the layout image of the second training image only indicates the area in which the foreground object cannot be generated, the specific position, the specific layout manner, or the like of the foreground object is not limited, and the flexibility of the image generation model is improved.

In the method, the image generation module and the layout control module in the image generation model are separately trained in a step-by-step training manner. The image generation module is first trained. Because the description information of the first training image describes both the background picture and the foreground objects, the background picture and the foreground objects in a generated image may be generated at one time, to enhance a correlation between the background picture and the foreground objects. After the training of the image generation module is completed, the layout control module is trained in combination with the trained image generation module. Because the layout image of the second training image indicates an area that does not include a foreground object, an area in which a foreground object cannot be generated in a generated image may be controlled, to implement controllable layout. In this way, the image generation model obtained through training may comprehensively consider the correlation between the background picture and the foreground objects in the generated image, and implement controllable layout at the same time, to meet diversified image generation requirements.

The training method for an image generation model provided in this embodiment of the present disclosure is described above. The following specifically describes the training data in the image generation model.

Image generation requirements in different service scenarios are often different. For example, expected styles of generated image and types of foreground objects may be different in different service scenarios. Therefore, in this embodiment of the present disclosure, the first training image may be related to a service scenario, that is, the first training image may be an image that meets an image generation requirement in the service scenario, so that the image generation module learns the image generation requirement in the service scenario, and generates an image that meets the service scenario.

Considering a training effect of the image generation module, the first training image may be a high-quality image. For example, the first training image may be a high-quality image from a designer.

In some possible implementations, in the training of the image generation module, training data of different sizes may be used for training. Specifically, one target training image set is randomly selected from a plurality of training image sets, a training image is randomly selected from the target training image set, and the randomly selected training image is determined as the first training image.

One training image set includes a plurality of training images with a same aspect ratio, and training images in different training image sets have different aspect ratios. In other words, the training image is cropped into images with a plurality of aspect ratios, and training images with a same aspect ratio are aggregated into one training image set. In a plurality of rounds of training processes of the image generation module, the target training image set is randomly selected, and the training image is randomly selected from the target training image set. In this way, multi-scale training is performed on the image generation module, so that the image generation module has a capability of generating images with different aspect ratios.

After the first training image is determined, the description information of the first training image may be determined based on the first training image. In this embodiment of the present disclosure, a manner of determining the description information of the first training image is not limited. For example, the description information of the first training image may be obtained through manual labeling. For another example, the description information of the first training image may alternatively be obtained by an image analysis model through analyzing the first training image.

Considering that the image generation model in this embodiment of the present disclosure may be applied to a template generation scenario, for example, a template generation scenario for video promotion, the second training data may be from a template image made by a designer. Specifically, a plurality of original images are obtained, where the original image includes a placeholder area and a text area; texts in the text area in the plurality of original images are erased, and the plurality of original images with texts erased are determined as the second training image.

The original image may be understood as a template image made by a designer, and the template image may be applied to video promotion. The placeholder area in the original image may be used to place a video material, and the text area in the original image may be used to place a promotional text.

Because the video material has not been placed in the original image, the placeholder area may be an area that does not include a foreground object. The text in the text area in the original image is erased, so that the text area also becomes an area that includes only a background picture and does not include a foreground object. In this way, a part of the area in the original image includes only the background picture, and then the second training image is determined.

After the second training image is determined, the description information of the second training image and the layout image of the second training image may be determined. In a specific implementation, the description information of the second training image may be determined in a manner similar to that of determining the description information of the first training image, and details are not described herein again.

Specifically, as to the process of determining the layout image of the second training image, for each of the plurality of original images, the following steps are performed: generating a blank image with a same image size as the original image, and determining an area in the blank image corresponding to the placeholder area and the text area in the original image as an area that does not include a foreground object, to obtain the layout image of the second training image corresponding to the original image.

Because the layout image does not include content, such as a background picture and a foreground object, that is not related to layout information, for each original image, a blank image is first generated, and then an area corresponding to the placeholder area and the text area in the blank image is determined as an area that does not include a foreground object, to convert the original image into the layout image.

In some embodiments, the layout image of the second training image may include a first area with a first label and a second area with a non-first label, the first area is an area that includes a foreground object, and the second area is an area that does not include a foreground object.

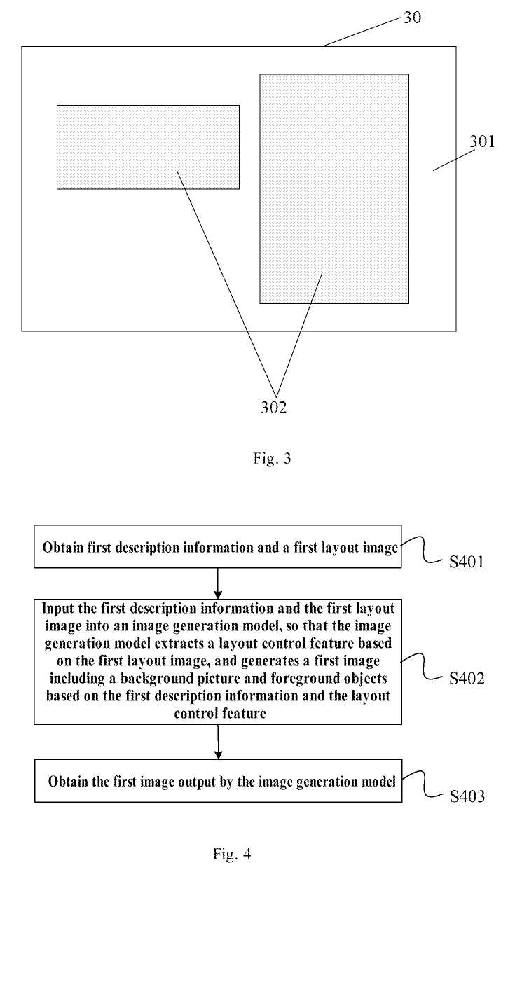

As shown in FIG. 3, the layout image 30 of the second training image includes a first area 301 with a first label (such as in white, or in a first texture) and a second area 302 with a non-first label (such as in gray, or in a second texture). The first area 301 is an area that includes a foreground object in the second training image, and the second area 302 is an area that does not include a foreground object in the second training image, for example, a placeholder area or a text area with the text erased.

In this way, different areas are distinguished by different labels in the layout image, and the layout control module extracts the layout control feature by learning the different labels in the layout image, thereby implementing layout control.

Based on the training method for an image generation model provided above, an embodiment of the present disclosure further provides an image generation method. FIG. 4 is a schematic flowchart of an image generation method. The method specifically includes the following steps.

S401: Obtain first description information and a first layout image.

The first description information is configured to describe a background picture and foreground objects of a desired image. The first layout image is configured to indicate an area that does not include a foreground object in the desired image.

That is, a user (for example, a service party with an image generation requirement) only needs to provide the first description information and the first layout image, to inform the image generation model of content included by the desired image through the first description information, and inform the image generation model of a layout position situation of the desired image through the first layout image, without providing information that describes a specific position, shape, color, or the like of the background picture or the foreground objects.

In this embodiment of the present disclosure, a source of the first description information is not limited. For example, the user may extract the first description information from an existing advertisement material. For another example, in a template generation scenario for video promotion, the user may alternatively extract the first description information from a video material.

In this embodiment of the present disclosure, a source of the first layout image is not limited. For example, the first layout image may be from a template image made by a designer. The template image is parsed to obtain a plurality of layout images, and the user may select the first layout image from the plurality of layout images.

S402: Input the first description information and the first layout image into an image generation model, so that the image generation model extracts a layout control feature based on the first layout image, and generates a first image including the background picture and the foreground objects based on the first description information and the layout control feature.

S403: Obtain the first image output by the image generation model.

The image generation model may be obtained through training based on a second image, description information of the second image, and a second layout image. The description information of the second image is configured to describe a background picture and foreground objects of the second image. The second layout image is configured to indicate an area that does not include a foreground object in the second image.

That is, by using the description information of the second image and the second layout image as inputs of the image generation model and the second image as a label, the image generation model may extract the layout control feature in combination with the layout image, and then generate an image in combination with the layout control feature and the description information, to enable a capability of generating an image that meets the layout image and the description information.

In the method, by inputting the first description information that describes the desired image and the first layout image that controls an area in which the foreground objects are located, the image generation model may generate the background picture and the foreground objects at one time, to improve a correlation between the background picture and the foreground objects. Because the first layout image is used as the input of the image generation model, a position of the foreground object in the first image is controllable, and the method may be applied to different service scenarios such as video promotion and material packaging.

Considering image quality of the image generated by the image generation model, this embodiment of the present disclosure may further optimize the image. As shown in FIG. 5, the image generation model may be obtained through training by using the training method for an image generation model provided above. The image generation model may further include an optimizer module. An output of the image generation module is one input of the optimizer module. The optimizer module is configured to perform refinement processing on the image.

In an inference process of the image generation model, the first description information and the first layout image are used as inputs of the layout control module in the image generation model, to obtain a first layout control feature output by the layout control module; the first description information and the first layout control feature are used as inputs of the image generation module in the image generation model, to obtain an initial image output by the image generation module; and the refinement processing is performed on the initial image by using the optimizer module in the image generation model, to obtain the first image output by the optimizer module.

A core principle of the optimizer module is to optimize the image by performing denoising processing. In this embodiment of the present disclosure, the denoising processing performed by the optimizer module may be divided into a plurality of steps. In each step, noise in the image is gradually reduced, and image quality is improved, so that the image is finer.

In this way, for the initial image output by the image generation module, the denoising processing is performed on the initial image by the optimizer module, so that the optimizer module outputs the first image with better image quality.

In the embodiments of the present disclosure, image optimization may be performed by using the optimizer module in different manners. In some embodiments, the first description information and the initial image are used as inputs of the optimizer module in the image generation model, so that the optimizer module performs first denoising processing on the initial image, to obtain the first image output by the optimizer module.

In some other embodiments, noise adding processing is performed on the initial image, and the first description information and the initial image with noise added are used as inputs of the optimizer module in the image generation model, so that the optimizer module performs second denoising processing on the initial image with noise added, to obtain the first image output by the optimizer module.

That is, the optimizer module may directly perform denoising processing on the initial image output by the image generation module, or may first perform noise adding processing on the initial image output by the image generation module, and then use the optimizer module to perform denoising processing on the initial image with noise added. In this way, in the manner in which the denoising processing is directly performed on the initial image output by the image generation module, the optimizer module reduces noise in the initial image, so that compared with the initial image, the first image blurs the background picture and makes a main object more prominent. In the manner in which the noise adding processing is first performed on the initial image output by the image generation module and then the denoising processing is performed, more content is added to the initial image through the noise adding processing, so that the first image has more image details and richer image information than the initial image. In addition, because the input of the optimizer module further includes the first description information, the first image matches the first description information better than the initial image, and better meets the image generation requirement of the user.

The training method for an image generation model and the image generation method provided in the embodiments of the present disclosure are described above in detail with reference to FIG. 1 to FIG. 5. The following describes apparatuses and devices provided in the embodiments of the present disclosure with reference to the drawings.

FIG. 6 is a schematic diagram of a structure of a training apparatus for an image generation model. The image generation model includes an image generation module and a layout control module. An output of the layout control module is one input of the image generation module. The image generation module is configured to generate an image. The layout control module is configured to control a layout of foreground objects in the image. The apparatus 60 includes:

an obtaining module 601, configured to obtain first training data, where the first training data includes a first training image and description information of the first training image, and the description information of the first training image is configured to describe a background picture and foreground objects of the first training image;

a training module 602, configured to use the description information of the first training image as an input of the image generation module, and train the image generation module by using the first training image as a label;

the obtaining module 601 is further configured to: after completing training of the image generation module, obtain second training data, where the second training data includes a second training image, description information of the second training image, and a layout image of the second training image, the description information of the second training image is configured to describe a background picture and foreground objects of the second training image, and the layout image of the second training image is configured to indicate an area that does not include a foreground object in the second training image;

a processing module 603, configured to use the description information of the second training image and the layout image of the second training image as inputs of the layout control module, to obtain a layout control feature output by the layout control module; and

the training module 602 is further configured to use the description information of the second training image and the layout control feature output by the layout control module as inputs of the trained image generation module, and train the layout control module by using the second training image as a label.

In some possible implementations, the layout image of the second training image includes a first area with a first label and a second area with a non-first label, the first area is an area that includes a foreground object, and the second area is an area that does not include a foreground object.

In some possible implementations, the obtaining module 601 is particularly configured to:

randomly select one target training image set from a plurality of training image sets, where one training image set includes a plurality of training images with a same aspect ratio, and training images in different training image sets have different aspect ratios;

randomly select a training image from the target training image set, and determine the randomly selected training image as the first training image; and

determine the description information of the first training image based on the first training image.

In some possible implementations, the obtaining module 601 is particularly configured to:

obtain a plurality of original images, where the original image includes a placeholder area and a text area;

erase texts in the text area in the plurality of original images, and determine the plurality of original images with texts erased as the second training image; and

determine the description information of the second training image based on the second training image, and determine the layout image of the second training image based on the second training image.

In some possible implementations, the obtaining module 601 is particularly configured to:

perform the following steps for each of the plurality of original images:

generating a blank image with a same image size as the original image; and

determining an area in the blank image corresponding to the placeholder area and the text area in the original image as an area that does not include a foreground object, to obtain the layout image of the second training image corresponding to the original image.

The training apparatus 60 for an image generation model according to this embodiment of the present disclosure may correspond to performing the method described in this embodiment of the present disclosure, and the foregoing and other operations and/or functions of the modules/units of the training apparatus 60 for an image generation model are respectively intended to implement the corresponding procedures of the methods in the embodiment shown in FIG. 2. For the sake of brevity, details are not described herein again.

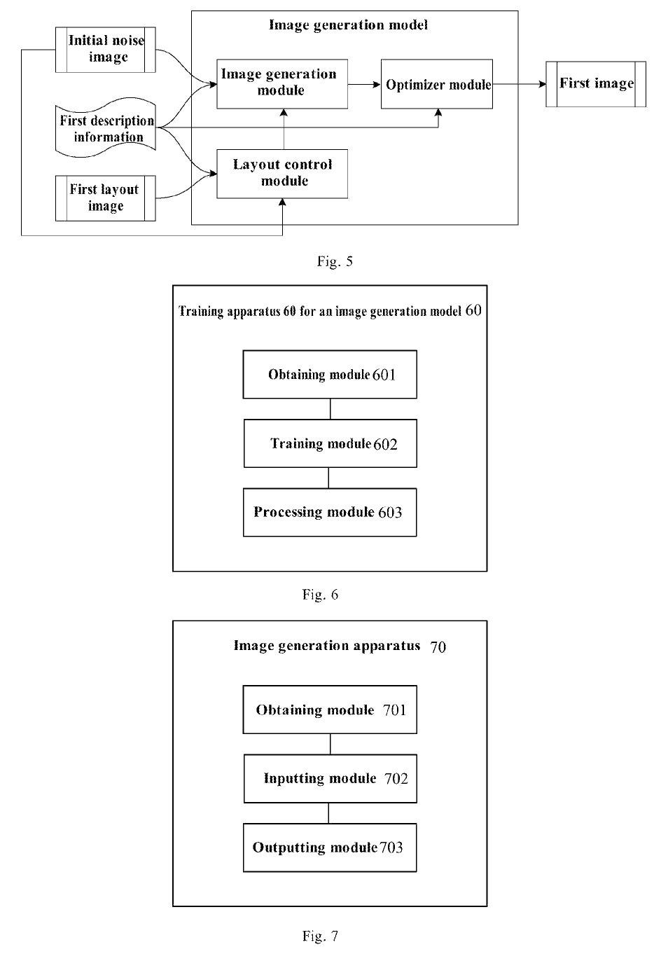

FIG. 7 is a schematic diagram of a structure of an image generation apparatus. The apparatus 70 includes:

an obtaining module 701, configured to obtain first description information and a first layout image, where the first description information is configured to describe a background picture and foreground objects of a desired image, and the first layout image is configured to indicate an area that does not include a foreground object in the desired image;

an inputting module 702, configured to input the first description information and the first layout image into an image generation model, so that the image generation model extracts a layout control feature based on the first layout image, and generates a first image including the background picture and the foreground objects based on the first description information and the layout control feature; and

an outputting module 703, configured to obtain the first image output by the image generation model, where the image generation model is obtained through training based on a second image, description information of the second image, and a second layout image, the description information of the second image is configured to describe a background picture and foreground objects of the second image, and the second layout image is configured to indicate an area that does not include a foreground object in the second image.

In some possible implementations, the image generation is obtained through training by using the foregoing training method for an image generation model, the image generation model further includes an optimizer module, an output of the image generation module is one input of the optimizer module, and the optimizer module is configured to perform refinement processing on an image.

In some possible implementations, the inputting module 702 is particularly configured to:

use the first description information and the first layout image as inputs of a layout control module in the image generation model, to obtain a first layout control feature output by the layout control module;

use the first description information and the first layout control feature as inputs of the image generation module in the image generation model, to obtain an initial image output by the image generation module; and

perform refinement processing on the initial image by using an optimizer module in the image generation model, to obtain the first image output by the optimizer module.

In some possible implementations, the inputting module 702 is further configured to:

use the first description information and the initial image as inputs of the optimizer module in the image generation model, so that the optimizer module performs first denoising processing on the initial image, to obtain the first image output by the optimizer module; or

perform noise adding processing on the initial image, and use the first description information and the initial image with the noise added as inputs of the optimizer module in the image generation model, so that the optimizer module performs second denoising processing on the initial image with the noise added , to obtain the first image output by the optimizer module.

The image generation apparatus 70 according to this embodiment of the present disclosure may correspond to performing the method described in this embodiment of the present disclosure, and the foregoing and other operations and/or functions of the modules/units of the image generation apparatus 70 are respectively intended to implement the corresponding procedures of the methods in the embodiment shown in FIG. 4. For the sake of brevity, details are not described herein again.

An embodiment of the present disclosure further provides an electronic device. The electronic device is further configured to implement a function of the training apparatus 60 for an image generation model in the embodiment shown in FIG. 6, or implement a function of the image generation apparatus 70 in the embodiment shown in FIG. 7.

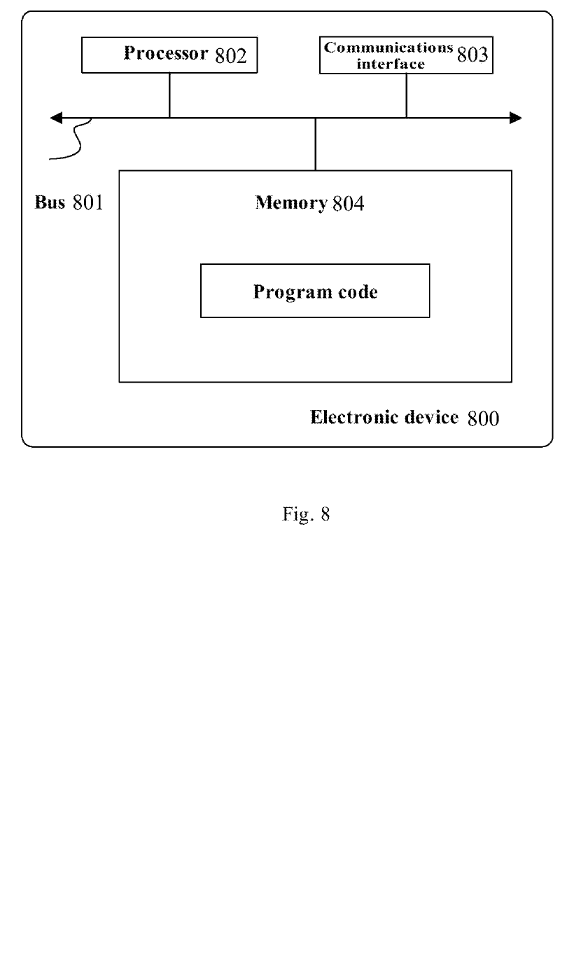

FIG. 8 is a schematic diagram of a structure of an electronic device 800. As shown in FIG. 8, the electronic device 800 includes a bus 801, a processor 802, a communications interface 803, and a memory 804. The processor 802, the memory 804, and the communications interface 803 communicate with each other through the bus 801.

The bus 801 may be a peripheral component interconnect (PCI) bus, an extended industry standard architecture (EISA) bus, or the like. The bus may be classified into an address bus, a data bus, a control bus, and the like. For ease of representation, only a thick line is configured to represent the bus in FIG. 8, but it does not mean that there is only one bus or one type of bus.

The processor 802 may be any one or more of a central processing unit (CPU), a graphics processing unit (GPU), a microprocessor (MP), a digital signal processor (DSP), and the like.

The communications interface 803 is configured to communicate with an external device. For example, the communications interface 803 may be configured to communicate with a terminal.

The memory 804 may include a volatile memory, for example, a random access memory (RAM). The memory 804 may further include a non-volatile memory, for example, a read-only memory (ROM), a flash memory, a hard disk drive (HDD), or a solid state drive (SSD).

The memory 804 stores executable code, and the processor 802 executes the executable code to perform the foregoing training method for an image generation model or the foregoing image generation method.

Specifically, in an implementation of the embodiment shown in FIG. 6 or FIG. 7, and when the modules or units of the training apparatus 60 for an image generation model described in the embodiment of FIG. 6 or the image generation apparatus 70 described in the embodiment of FIG. 7 are implemented in software, software or program code required to perform functions of the modules/units in FIG. 6 or FIG. 7 may be partially or entirely stored in the memory 804. The processor 802 executes program code corresponding to the units and stored in the memory 804, to perform the foregoing training method for an image generation model or the foregoing image generation method.

An embodiment of the present disclosure further provides a computer-readable storage medium. The computer-readable storage medium may be any usable medium that may be stored by a computing device, or a data storage device, such as a data center, that includes one or more usable media. The usable medium may be a magnetic medium (for example, a floppy disk, a hard disk, or a magnetic tape), an optical medium (for example, a DVD), a semiconductor medium (for example, a solid state disk), or the like. The computer-readable storage medium includes instructions, and the instructions instruct a computing device to perform the foregoing training method for an image generation model that is applied to the training apparatus 60 for an image generation model, or perform the foregoing image generation method that is applied to the image generation apparatus 70.

An embodiment of the present disclosure further provides a computer program product including one or more computer instructions. When the computer instructions are loaded and executed on a computing device, all or some of the processes or functions according to the embodiments of the present disclosure are generated.

The computer instructions may be stored in a computer-readable storage medium or may be transmitted from one computer-readable storage medium to another computer-readable storage medium. For example, the computer instructions may be transmitted from one website, computer, or data center to another website, computer, or data center in a wired (for example, a coaxial cable, an optical fiber, or a digital subscriber line (DSL)) or wireless (for example, infrared, radio, or microwave) manner.

When the computer program product is executed by a computer, the computer performs any one of the foregoing training method for an image generation model or the foregoing image generation method. The computer program product may be a software installation package. When any one of the foregoing training method for an image generation model or the foregoing image generation method needs to be used, the computer program product may be downloaded and executed on a computer.

The flowcharts and block diagrams in the drawings illustrate the possibly implemented architectures, functions, and operations of the system, the method, and the computer program product according to the embodiments of the present disclosure. In this regard, each block in the flowchart or block diagram may represent a module, program segment, or part of code, and the module, program segment, or part of code contains one or more executable instructions for implementing the specified logical function. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented in software or hardware. The name of a unit/module does not constitute a limitation on the unit itself in some cases.

The functions described above herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), and the like.

In the context of the embodiments of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include but is not limited to an electronic, magnetic, optical, electromagnetic, infrared, or semiconductor system, apparatus, or device, or any suitable combination of the foregoing. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

It should be noted that the embodiments in this specification are described in a progressive manner. Each embodiment focuses on a difference from other embodiments, and the same or similar parts between the embodiments may be referred to each other. For the system or apparatus disclosed in the embodiments, because it corresponds to the method disclosed in the embodiments, the description is relatively simple, and reference may be made to the description of the method for the related part.

It should be understood that in the present disclosure, "at least one (item)" means one or more, and "a plurality of" means two or more. "And/or" describes an association relationship between associated objects, and represents that three relationships may exist. For example, "A and/or B" may represent the following three cases: Only A exists, only B exists, and both A and B exist, where A and B may be singular or plural. The character "/" generally indicates an "or" relationship between the associated objects. "At least one of the following items (pieces)" or a similar expression thereof indicates any combination of these items, including a single item (piece) or any combination of a plurality of items (pieces). For example, at least one of a, b, or c may represent: a, b, c, "a and b", "a and c", "b and c", or "a, b, and c", where a, b, and c may be singular or plural.

It should be further noted that in this specification, relational terms such as first and second are used only to distinguish one entity or operation from another entity or operation, and do not necessarily require or imply any actual relationship or order between these entities or operations. Moreover, the terms "include", "include", or any other variant thereof are intended to cover non-exclusive inclusion, so that a process, method, object, or device that includes a plurality of elements includes not only those elements, but also other elements not explicitly listed or elements inherent to such a process, method, object, or device. Without further restrictions, an element defined by the phrase "includes a" does not exclude that another same element exists in the process, method, object, or device that includes the element.

Steps of the method or algorithm described in conjunction with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or a storage medium of any other form known in the art.

The foregoing descriptions of the disclosed embodiments enable those skilled in the art to implement or use the present disclosure. Various modifications to these embodiments will be apparent to those skilled in the art, and the generic principles defined herein may be implemented in other embodiments without departing from the spirit or scope of the present disclosure. Therefore, the present disclosure will not be limited to the embodiments shown herein, but rather to the widest scope consistent with the principles and novel features disclosed herein.

1. A training method for an image generation model, wherein the image generation model comprises an image generation module and a layout control module, an output of the layout control module is an input of the image generation module, the image generation module is configured to generate an image, and the layout control module is configured to control a layout of foreground objects in the image; and the method comprises:
obtaining first training data, wherein the first training data comprises a first training image and description information of the first training image, and the description information of the first training image is configured to describe a background picture and foreground objects of the first training image;
using the description information of the first training image as an input of the image generation module, and training the image generation module by using the first training image as a label;
after completing training of the image generation module, obtaining second training data, wherein the second training data comprises a second training image, description information of the second training image, and a layout image of the second training image, the description information of the second training image is configured to describe a background picture and foreground objects of the second training image, and the layout image of the second training image is configured to indicate an area that does not comprise a foreground object in the second training image;
using the description information of the second training image and the layout image of the second training image as inputs of the layout control module, to obtain a layout control feature output by the layout control module; and
using the description information of the second training image and the layout control feature output by the layout control module as inputs of the trained image generation module, and training the layout control module by using the second training image as a label.

2. The method of claim 1, wherein the layout image of the second training image comprises a first area with a first label and a second area with a non-first label, the first area is an area that comprises a foreground object, and the second area is an area that does not comprise a foreground object.

3. The method of claim 1, wherein the obtaining first training data comprises:
randomly selecting one target training image set from a plurality of training image sets, wherein one training image set comprises a plurality of training images with a same aspect ratio, and training images in different training image sets have different aspect ratios;
randomly selecting a training image from the target training image set, and determining the randomly selected training image as the first training image; and
determining the description information of the first training image based on the first training image.

4. The method of claim 1, wherein the obtaining second training data comprises:
obtaining a plurality of original images, wherein the original image comprises a placeholder area and a text area;
erasing texts in the text area in the plurality of original images, and determining the plurality of original images with texts erased as the second training image; and
determining the description information of the second training image based on the second training image, and determining the layout image of the second training image based on the second training image.

5. The method of claim 4, wherein the determining the layout image of the second training image based on the second training image comprises:
performing the following steps for each of the plurality of original images:
generating a blank image with a same image size as the original image; and
determining an area in the blank image corresponding to the placeholder area and the text area in the original image as an area that does not comprise a foreground object, to obtain the layout image of the second training image corresponding to the original image.

6. An image generation method, characterized by comprising:
obtaining first description information and a first layout image, wherein the first description information is configured to describe a background picture and foreground objects of a desired image, and the first layout image is configured to indicate an area that does not comprise a foreground object in the desired image;
inputting the first description information and the first layout image into an image generation model, so that the image generation model extracts a layout control feature based on the first layout image, and generates a first image comprising the background picture and the foreground objects based on the first description information and the layout control feature; and
obtaining the first image output by the image generation model, wherein the image generation model is obtained through training based on a second image, description information of the second image, and a second layout image, the description information of the second image is configured to describe a background picture and foreground objects of the second image, and the second layout image is configured to indicate an area that does not comprise a foreground object in the second image.

7. The method of claim 6, wherein the image generation model is obtained through training by using a training method for an image generation model, wherein the image generation model comprises an image generation module and a layout control module, an output of the layout control module is an input of the image generation module, the image generation module is configured to generate an image, and the layout control module is configured to control a layout of foreground objects in the image, and the training method comprises:
obtaining first training data, wherein the first training data comprises a first training image and description information of the first training image, and the description information of the first training image is configured to describe a background picture and foreground objects of the first training image;
using the description information of the first training image as an input of the image generation module, and training the image generation module by using the first training image as a label;
after completing training of the image generation module, obtaining second training data, wherein the second training data comprises a second training image, description information of the second training image, and a layout image of the second training image, the description information of the second training image is configured to describe a background picture and foreground objects of the second training image, and the layout image of the second training image is configured to indicate an area that does not comprise a foreground object in the second training image;
using the description information of the second training image and the layout image of the second training image as inputs of the layout control module, to obtain a layout control feature output by the layout control module; and
using the description information of the second training image and the layout control feature output by the layout control module as inputs of the trained image generation module, and training the layout control module by using the second training image as a label;
wherein the image generation model further comprises an optimizer module, an output of the image generation module is one input of the optimizer module, and the optimizer module is configured to perform refinement processing on an image.

8. The method of claim 7, wherein the inputting the first description information and the first layout image into an image generation model, so that the image generation model extracts a layout control feature based on the first layout image, and generates a first image comprising the background picture and the foreground objects based on the first description information and the layout control feature comprises:
using the first description information and the first layout image as inputs of a layout control module in the image generation model, to obtain a first layout control feature output by the layout control module;
using the first description information and the first layout control feature as inputs of the image generation module in the image generation model, to obtain an initial image output by the image generation module; and
performing refinement processing on the initial image by using an optimizer module in the image generation model, to obtain the first image output by the optimizer module.

9. The method of claim 8, wherein the performing refinement processing on the initial image by using an optimizer module in the image generation model, to obtain the first image output by the optimizer module comprises:
using the first description information and the initial image as inputs of the optimizer module in the image generation model, so that the optimizer module performs first denoising processing on the initial image, to obtain the first image output by the optimizer module; or
performing noise adding processing on the initial image, and using the first description information and the initial image with noise added as inputs of the optimizer module in the image generation model, so that the optimizer module performs second denoising processing on the initial image with noise added, to obtain the first image output by the optimizer module.

10. An electronic device, wherein the electronic device comprises a processor and a memory; and
the processor is configured to execute instructions stored in the memory, to cause the electronic device to perform an image generation method, comprising:
obtaining first description information and a first layout image, wherein the first description information is configured to describe a background picture and foreground objects of a desired image, and the first layout image is configured to indicate an area that does not comprise a foreground object in the desired image;
inputting the first description information and the first layout image into an image generation model, so that the image generation model extracts a layout control feature based on the first layout image, and generates a first image comprising the background picture and the foreground objects based on the first description information and the layout control feature; and
obtaining the first image output by the image generation model, wherein the image generation model is obtained through training based on a second image, description information of the second image, and a second layout image, the description information of the second image is configured to describe a background picture and foreground objects of the second image, and the second layout image is configured to indicate an area that does not comprise a foreground object in the second image.

11. The device of claim 10, wherein the image generation model is obtained through training by using a training method for an image generation model, wherein the image generation model comprises an image generation module and a layout control module, an output of the layout control module is an input of the image generation module, the image generation module is configured to generate an image, and the layout control module is configured to control a layout of foreground objects in the image, and the training method comprises:
obtaining first training data, wherein the first training data comprises a first training image and description information of the first training image, and the description information of the first training image is configured to describe a background picture and foreground objects of the first training image;
using the description information of the first training image as an input of the image generation module, and training the image generation module by using the first training image as a label;
after completing training of the image generation module, obtaining second training data, wherein the second training data comprises a second training image, description information of the second training image, and a layout image of the second training image, the description information of the second training image is configured to describe a background picture and foreground objects of the second training image, and the layout image of the second training image is configured to indicate an area that does not comprise a foreground object in the second training image;
using the description information of the second training image and the layout image of the second training image as inputs of the layout control module, to obtain a layout control feature output by the layout control module; and
using the description information of the second training image and the layout control feature output by the layout control module as inputs of the trained image generation module, and training the layout control module by using the second training image as a label;
wherein the image generation model further comprises an optimizer module, an output of the image generation module is one input of the optimizer module, and the optimizer module is configured to perform refinement processing on an image.

12. The device of claim 11, wherein the inputting the first description information and the first layout image into an image generation model, so that the image generation model extracts a layout control feature based on the first layout image, and generates a first image comprising the background picture and the foreground objects based on the first description information and the layout control feature comprises:
using the first description information and the first layout image as inputs of a layout control module in the image generation model, to obtain a first layout control feature output by the layout control module;
using the first description information and the first layout control feature as inputs of the image generation module in the image generation model, to obtain an initial image output by the image generation module; and
performing refinement processing on the initial image by using an optimizer module in the image generation model, to obtain the first image output by the optimizer module.

13. The device of claim 12, wherein the performing refinement processing on the initial image by using an optimizer module in the image generation model, to obtain the first image output by the optimizer module comprises:
using the first description information and the initial image as inputs of the optimizer module in the image generation model, so that the optimizer module performs first denoising processing on the initial image, to obtain the first image output by the optimizer module; or
performing noise adding processing on the initial image, and using the first description information and the initial image with noise added as inputs of the optimizer module in the image generation model, so that the optimizer module performs second denoising processing on the initial image with noise added, to obtain the first image output by the optimizer module.

14. A non-transitory computer-readable storage medium, characterized by comprising instructions, wherein the instructions instruct an electronic device to perform the method of claim 1.

15. A non-transitory computer-readable storage medium, characterized by comprising instructions, wherein the instructions instruct an electronic device to perform the method of claim 2.

16. A non-transitory computer-readable storage medium, characterized by comprising instructions, wherein the instructions instruct an electronic device to perform the method of claim 6.

17. A non-transitory computer-readable storage medium, characterized by comprising instructions, wherein the instructions instruct an electronic device to perform the method of claim 7.

18. A non-transitory computer-readable storage medium, characterized by comprising instructions, wherein the instructions instruct an electronic device to perform the method of claim 8.

19. An electronic device, wherein the electronic device comprises a processor and a memory; and
the processor is configured to execute instructions stored in the memory, to cause the electronic device to perform the image generation method according to claim 1.

20. An electronic device, wherein the electronic device comprises a processor and a memory; and
the processor is configured to execute instructions stored in the memory, to cause the electronic device to perform the image generation method according to claim 2.
